(19) United States
(12) Patent Application Publication
(10) Pub. No.: US 2025/0074652 A1
(43) Pub. Date: Mar. 6, 2025

(54) STORAGE APPARATUS WITH VENTILATION HOLES

(71) Applicant: Roy Peer, Riverview, FL (US)

(72) Inventor: Roy Peer, Riverview, FL (US)

(21) Appl. No.: 18/616,766

(22) Filed: Mar. 26, 2024

Related U.S. Application Data
(63) Continuation-in-part of application No. 18/484,968, filed on Oct. 11, 2023, now abandoned.
(60) Provisional application No. 63/579,928, filed on Aug. 31, 2023.

(51) Int. Cl. B65D 21/02; B05B 11/00

(52) U.S. Cl. CPC B65D 21/0228; B05B 11/0037; B65D 2205/02; B65D 2209/00; B65D 2313/00

(57) ABSTRACT

A storage apparatus with variable storage capacity, wherein items can be stored in an isolated manner. The storage apparatus includes a main compartment and additional compartments. The main compartment and the additional compartment include an interlocking mechanism for coupling the additional compartment to the main compartment, and for coupling the additional compartment to another additional compartment. The additional compartments can have one or more ventilation holes.

### CROSS-REFERENCE TO RELATED APPLICATIONS

This application is a continuation-in-part of a U.S. patent application. No. 18/484,968 filed on Oct. 11, 2023, which claims priority from a U.S. provisional patent application Ser. No. 63/579,928 filed on Aug. 31, 2023, both of which are incorporated herein by reference in its entirety.

### FIELD OF INVENTION

The present invention relates to a storage apparatus, and more particularly, the present invention relates to a modular and scalable container-based storage apparatus in which additional compartments can be added and removed, and the additional compartments that have ventilation holes.

### BACKGROUND

Containers are widely used for the storage and transport of a variety of products, including solids, semi-solids, liquids, and gases. Containers of different sizes, shapes, and types are used for different products. The use of containers is almost universal in day-to-day life and for commercial purposes.

The known containers have one major limitation, i.e., limited storage capacity. The known container designs have no provision for expandable storage, such as for storing more content or different products in an isolated manner.

Thus, a need is always appreciated for improvements in existing storage systems.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a storage apparatus that has additional compartments for storage.

Another object of the present invention is that the storage apparatus is economical to manufacture.

Yet another object of the present invention is that the apparatus is versatile for storage.

An additional object of the present invention is that the storage space can be well-ventilated.

It is a further object of the present invention that any mildew growth due to poor ventilation can be prevented.

Still, a further object of the present invention is that any odor buildup inside the compartments can be prevented.

Yet a further object of the present invention is that compartments can be interchangeably used.

In one aspect, disclosed is a storage apparatus comprising a main compartment having a mouth at a top and a closed base, and a first interlocking member disposed at a lower wall portion of the main compartment; and a first additional compartment having an open top and a closed base, a second interlocking member disposed at an upper wall portion of the first additional compartment, wherein the first interlocking member and the second interlocking member are configured to engage for coupling the first additional compartment to the main compartment, the first additional compartment comprises a first interlocking member disposed at a lower wall portion thereof. The storage apparatus further comprises a second additional compartment, the second additional compartment has a second interlocking member disposed at an upper wall portion thereof, and a first interlocking member at a lower wall portion thereof, wherein the second interlocking member of the second additional compartment and the first interlocking member of the first additional compartment are configured to engage for coupling the second additional compartment to the first additional compartment. The storage apparatus further comprises a third additional compartment configured to couple to the second additional compartment.

In one aspect, the main compartment is larger than the first additional compartment. The main compartment has spray functionality, wherein a spray head is coupled to the mouth of the main compartment. The first interlocking member and the second interlocking member engage through a snap-fit mechanism.

In one aspect, disclosed is a method for varying storage capacity, the method comprising providing a storage apparatus. The storage apparatus comprises a main compartment having a mouth at a top and a closed base, and a first interlocking member disposed at a lower wall portion of the main compartment; and a first additional compartment having an open top and a closed base, a second interlocking member disposed at an upper wall portion of the first additional compartment, wherein the first interlocking member and the second interlocking member are configured to engage for coupling the first additional compartment to the main compartment, the first additional compartment comprises a first interlocking member disposed at a lower wall portion thereof. The method further comprises attaching the first additional compartment to the main compartment.

In one aspect, one or more of the compartments can have ventilation holes in the walls thereof. Each compartment can have one or more ventilation holes. Through these ventilation holes, the inner volume of the compartment can be ventilated. The air can circulate from outside to inside and from inside to outside of the compartments.

In one aspect, each compartment can have two ventilation holes in opposite walls of the respective compartment.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of a storage apparatus, according to an exemplary embodiment of the present invention.

FIG. 2 shows a partially exploded view of the storage apparatus of FIG. 1, according to an exemplary embodiment of the present invention.

FIG. 3 shows another embodiment of the storage apparatus in which the compartments have ventilation holes, according to an exemplary embodiment of the present invention.

FIG. 4 shows another embodiment of the storage apparatus in which the compartments have two ventilation holes, according to the present invention.

### DETAILED DESCRIPTION

Subject matter will now be described more fully hereinafter with reference to the accompanying drawings, which form a part hereof and which show, by way of illustration, specific exemplary embodiments. Subject matter may, however, be embodied in a variety of different forms, and, therefore, covered or claimed subject matter is intended to be construed as not being limited to any exemplary embodiments set forth herein; exemplary embodiments are provided merely to be illustrative. Likewise, a broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

A storage apparatus is disclosed that includes a main compartment and additional compartments. The capacity of the disclosed storage apparatus can be varied by adding and removing the additional compartments. Moreover, items of different types are stored in the disclosed apparatus in an isolated manner. The additional compartments can be coupled as and when desired. Moreover, attaching and removing the additional compartments is quick and easy. To the main compartment can be added one additional compartment, and to each additional compartment, another additional compartment can be added. The additional compartments can be added lengthwise, i.e., along the longitudinal axis of the storage apparatus. With the additional compartments, the length of the storage apparatus is increased without significantly modifying the width of the storage apparatus. The shape and size of additional compartments can be varied respective to the main container.

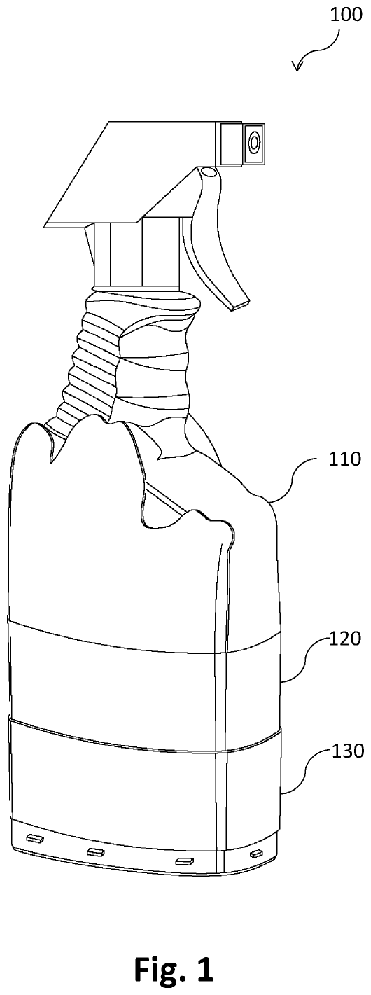

The main compartment is the primary storage compartment of the storage apparatus and is larger compared to the additional compartments. The main compartment may also have additional functionalities, such as spray functionality. The main compartment can be of any suitable shape, such as cylindrical, rectangular, and the like. The size and shape of the main compartment may primarily depend on its application. For example, FIG. 1 shows the storage apparatus 100 having a main compartment 110, a first additional compartment 120, and a second additional compartment 130. The main compartment has an elongated rectangular profile and includes spray functionality. The main compartment 110 has an open mouth and a closed bottom. A nozzle head 140 is coupled to the open mouth of the main compartment. It is to be understood that the drawings show a spray head is for illustration only, however, any other functionality is within the scope of the present invention.

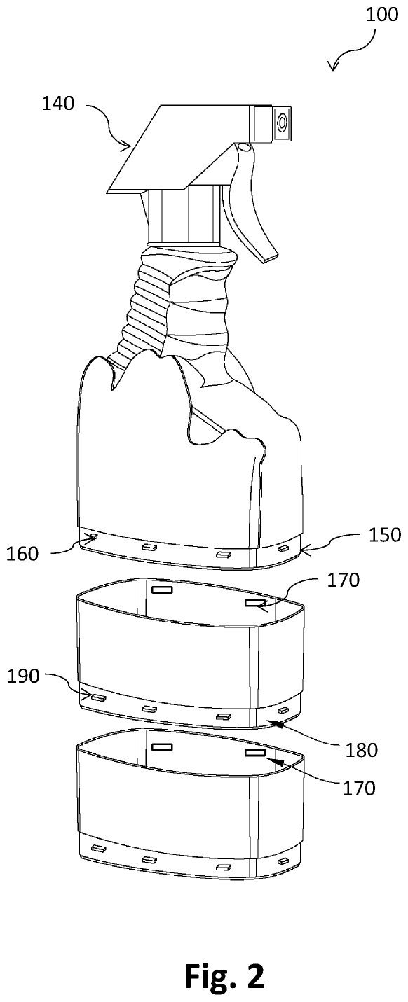

A lower wall portion of the main compartment includes an attachment member for releasably attaching an additional compartment to the main compartment. FIG. 2 is an exploded view showing the main compartment 110, the second additional compartment 120, and the third additional compartment. The lower wall portion of the main compartment 150 has a first interlocking member 160 and an upper wall portion has a second interlocking member 170, wherein the first and second interlocking members can engage and disengage for coupling the additional compartment to the main compartment. A lower wall portion 180 of the additional compartment also has the interlocking member 190 that allows the additional compartment to couple to another additional compartment.

Each of the additional compartments has an open top, wherein the inner width of the top of the additional compartment corresponds to the outer width of the lower wall portion of the main compartment. The inner wall of the additional compartment has a second interlocking member. In use, the additional compartment can be placed below the main compartment, and then the additional compartment can be fastened to the main compartment. To remove the same, the additional compartment can be unfastened.

The interlocking mechanism or attachment mechanism for coupling the additional compartment to the main compartment may vary depending on the size and shape of the two compartments. For example, the interlocking mechanism can be screw threads, wherein the main compartment and the additional compartment can have corresponding threads, and the additional compartment can be fastened to the main compartment by turning the same to engage the threads of the additional compartment with those of the main compartment. Provision of screw threads may be possible in cylindrical types of compartments. The number of threads can also be varied; for example, fewer threads may allow quicker coupling, while a greater number of threads may provide structural integrity.

Another interlocking mechanism can be the snap-fit mechanism, which includes a first interlocking member and a second interlocking member in the form of interlocking tabs. The drawings show a snap-fit mechanism. It is a more universal type of interlocking mechanism that can be used with different shapes of the main compartment and additional compartment. The main compartment and the additional compartments have tabs, and to secure the additional compartment on the main compartment, the tabs can be positioned in contact with each other, and some force is applied for the tabs to snap over. Similarly, some force must be applied to release the additional compartment from the main compartment. Such interlocking mechanisms can be used in rectangular, square, round, hexagonal, and the like-shaped compartments.

Other interlocking mechanisms, such as the use of adhesives, hooks, loop fasteners, and the like, can be incorporated, and any such interlocking mechanism is within the scope of the present invention.

Also, the embodiment described above, i.e., the outer wall portion of the main compartment and the inner wall of the additional compartment having the interlocking member, is for illustration only without limiting the scope of the present invention. For example, the main compartment can have a skirt that extends downwards from the base of the main compartment, and the inner surface of the skirt may have the first interlocking member and the additional member on its outer wall surface may have the second interlocking member for coupling the two together.

The storage apparatus may also allow for the attachment of additional compartments. The first additional compartment can be coupled to the main compartment; a second additional compartment can be coupled to the first additional compartment; a third additional compartment can be coupled to the second compartment; and so on. The first, second, third, and other additional compartments can be the same or different i.e., of different shapes and sizes. The additional compartments can be interchangeably used.

The additional compartments can also have interlocking members, as described above for the main compartment and the additional compartment. The upper wall portion of the additional compartment on its outer or inner surface may have interlocking members for attaching to another additional compartment. The bottom wall portion may have on the outer surface the interlocking member for attaching the additional compartment. A skirt, as described above for the main compartment, can also be provided for the additional compartments.

The additional compartment can be of the same or different shapes. For example, the first additional compartment, the second additional compartment, and the third additional compartment may be different in size and/or shape.

The storage apparatus may be made from materials, such as metal or plastic. The material for the main compartment and the additional compartments can be the same or different. Moreover, storage apparatus can be manufactured in a range of colors and designs.

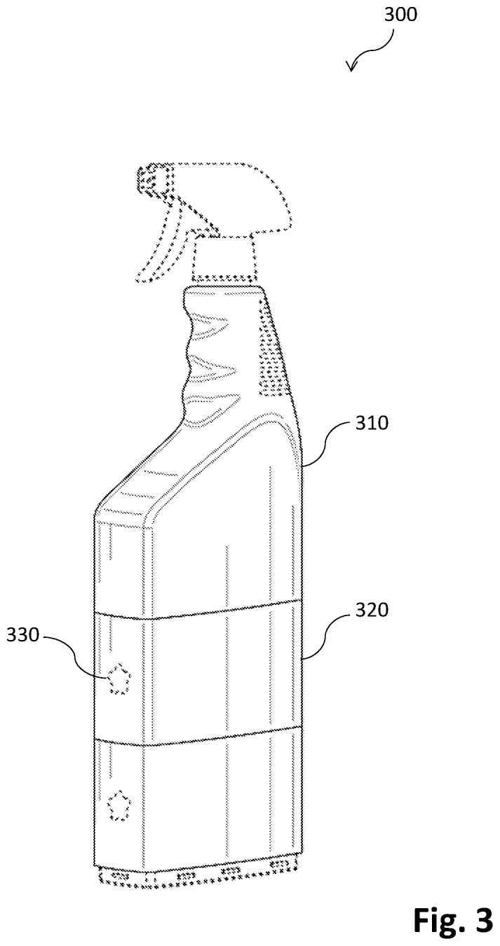

Referring to FIG. 3 which shows another embodiment of the storage apparatus 300. As described above the storage apparatus includes a main container 310 and additional compartments 320. The additional compartments can be interchangeably coupled to the bottom of the main container. One or more of the additional compartments can have ventilation of holes 330 for circulation of air inside the respective compartment. Depending upon use, any number of compartments with ventilation holes can be attached to the main container. For example, FIG. 3 shows all the additional compartments have ventilation holes. Preferably, a kit can be included that includes both types of compartments i.e., the compartments with and without ventilation holes. Thus, depending on the requirement, the user can use any type of compartment with the main container.

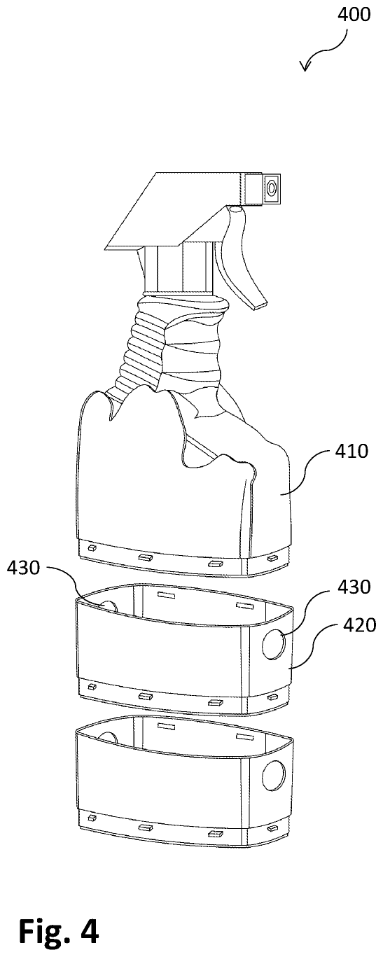

Referring to FIG. 4 which shows another embodiment of the storage apparatus 400. As described above, the storage apparatus includes a main container 410 and additional compartments 420. The additional compartments can be interchangeably coupled to the bottom of the main container. One or more of the additional compartments can have ventilation holes 430 for circulation of air inside the respective compartment. Depending upon the use, any number of compartments with ventilation holes can be attached to the main container. For example, FIG. 4 shows all the additional compartments have ventilation holes. Preferably, ventilation holes can be provided on opposite side walls of the compartment so that air can be circulated. For example, the outside air can replace the inside air of the compartment from one hole and the inside air can circulate outside through another hole. One or more of the additional compartments can be included, each having two ventilation holes. Preferably, a kit can be included in which both types of compartments, i.e., with and without the ventilation holes can be included. Thus, depending upon the use, the user can choose any type of compartment with the main container.

The disclosed storage apparatus with ventilated compartments is advantageous by allowing air circulation while maintaining the overall aesthetic and functionality of the storage apparatus. The ventilation is primarily intended for storing items, such as microfiber cloths or sponges. The air holes in the interchangeable compartments facilitate drying and preventing the buildup of odors and mildew, thereby prolonging the usability and hygiene of the stored items. Preferably, the ventilation holes can be strategically sized and positioned to maximize airflow while preventing the entry of larger particles. In a preferred embodiment, the ventilation holes can be covered with a fine mesh or filter material to enhance this protective function. These ventilated compartments are interchangeable with the standard non-ventilated compartments, offering the users the flexibility to customize the storage apparatus based on their storage needs. The compartments with the ventilation holes can be made from suitable materials. The choice of materials takes into consideration the various factors like moisture resistance and ease of cleaning.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A storage apparatus comprising:
a main container having a mouth at a top and a closed base, and a first interlocking member disposed at a lower wall portion of the main compartment; and
a first additional compartment having an open top and a closed base, a second interlocking member disposed at an upper wall portion of the first additional compartment, wherein the first interlocking member and the second interlocking member are configured to engage for coupling the first additional compartment to the main compartment, the first additional compartment comprises a first interlocking member disposed at a lower wall portion thereof, the first additional compartment has one or more ventilation holes.

2. The storage apparatus of claim 1, wherein the storage apparatus further comprises a second additional compartment, the second additional compartment has a second interlocking member disposed at an upper wall portion thereof, and a first interlocking member at a lower wall portion thereof, wherein the second interlocking member of the second additional compartment and the first interlocking member of the first additional compartment are configured to engage for coupling the second additional compartment to the first additional compartment.

3. The storage apparatus of claim 2, wherein the storage apparatus further comprises a third additional compartment configured to couple to the second additional compartment.

4. The storage apparatus of claim 2, wherein the main compartment is larger than the first additional compartment.

5. The storage apparatus of claim 4, wherein the main compartment has spray functionality, wherein a spray head is coupled to the mouth of the main compartment.

6. The storage apparatus of claim 1, wherein the first interlocking member and the second interlocking member engage through a snap-fit mechanism.

7. The storage apparatus of claim 1, wherein the one or more ventilation holes comprises two ventilation holes in opposite walls of the first additional compartment.

8. A method for varying storage capacity, the method comprising:
providing a storage apparatus comprising:
a main compartment having a mouth at a top and a closed base, and a first interlocking member disposed at a lower wall portion of the main compartment; and
a first additional compartment having an open top and a closed base, a second interlocking member disposed at an upper wall portion of the first additional compartment, wherein the first interlocking member and the second interlocking member are configured to engage for coupling the first additional compartment to the main compartment, the first additional compartment comprises a first interlocking member disposed at a lower wall portion thereof, wherein the first additional compartment comprises one or more ventilation holes; and
attaching the first additional compartment to the main compartment.

9. The method of claim 8, wherein the storage apparatus further comprises a second additional compartment, the second additional compartment has a second interlocking member disposed at an upper wall portion thereof, and a first interlocking member at a lower wall portion thereof, wherein the second interlocking member of the second additional compartment and the first interlocking member of the first additional compartment are configured to engage for coupling the second additional compartment to the first additional compartment.

10. The method of claim 9, wherein the storage apparatus further comprises a third additional compartment configured to couple to the second additional compartment.

11. The method of claim 9, wherein the main compartment is larger than the first additional compartment.

12. The method of claim 11, wherein the main compartment has a spray functionality, wherein a spray head is coupled to the mouth of the main compartment.

13. The method of claim 8, wherein the first interlocking member and the second interlocking member engage through a snap-fit mechanism.

14. The method apparatus of claim 8, wherein the one or more ventilation holes comprises two ventilation holes in opposite walls of the first additional compartment.

15. The method of claim 14, wherein the method further comprises:
placing at least a partially wet article in the first additional compartment, wherein the partially wet article is dried by the ventilation.

16. The method of claim 15, wherein the partially wet article is a microfiber cleaning cloth or a sponge.
